(19) United States
(12) Patent Application Publication
(10) Pub. No.: US 2002/0086639 A1
(43) Pub. Date: Jul. 4, 2002

(54) Air interface frame structure for environments with bursted interference

(75) Inventor: Juergen Kockmann, Duesseldorf (DE)

Correspondence Address: Siemens Corporation, Intellectual Property Department, 186 Wood Avenue South, Iselin, NJ, 08830, US

(73) Assignee: Siemens Information and Communication Products, Inc.

(21) Appl. No.: 09/751,521

(22) Filed: Dec. 28, 2000

(51) Int. Cl. H04B 15/00

(52) U.S. Cl. 455/62; 455/462; 455/561

(57) ABSTRACT

A base station (12) according to an implementation of the invention is adapted to identify a public power supply frequency, e.g., 50 Hz or 60 Hz. The base station (12) then adapts its frame and slot structures to the power supply frequency. The base station (12) transmits a synchronization word on a data channel, and also transmits a signal indicative of the power supply frequency. The mobile unit (14, 16) receives the data channel and the information indicative of the frequency. The mobile unit (14, 16) then adapts its frame and slot structure appropriately. After the link is established, and if periodic interference is detected, transmission occurs during the inactive period of the interference.

### BACKGROUND OF THE INVENTION

1. Field of the Invention

The present invention relates to telecommunication systems and, particularly, to a system that is more robust against in-band interferers.

2. Description of the Related Art

Cordless time division multiple access (TDMA) systems that operate in the ISM (industrial-science-medicine) band are often interfered with by periodically bursted, wide bandwidth interferers. For example, such interferers can have bandwidths of one third or one half of the entire available ISM bandwidth.

For example, in the 2.4 GHz band a TDMA system will be interfered with by a variety of bursted interferers, such as microwave ovens. Such devices are active periodically, typically according to the frequency of the power supply. FIG. 1 illustrates the interference from such a microwave oven. The signal has a period T, representative of a frequency of either 50 or 60 Hz.

There is therefore a need for a system to compensate for such periodically bursted interferers.

### SUMMARY OF THE INVENTION

These and other drawbacks in the prior art are overcome in large part by a system and method according to the present invention. A telecommunications system is provided, including a base station and one or more mobile units. The base station is adapted to detect an active interferer and transmit only during the inactive time.

A cordless telephone system configured to adapt a frame and slot structure to the public power supply frequency is provided. In a 50 Hz system, a frame length is 20 milliseconds. In a 60 Hz system, a frame length is 16.6 milliseconds. The speech codec rate may be maintained the same if it is a multiple of 50 and 60. Only the number of bits per frame is changed.

A base station according to an implementation of the invention is adapted to identify a public power supply frequency, e.g., 50 Hz or 60 Hz. The base station then adapts its frame and slot structures to the power supply frequency. The base station transmits a synchronization word on a data channel, and also transmits a signal indicative of the power supply frequency. The mobile unit receives the data channel and the information indicative of the frequency. The mobile unit then adapts its frame and slot structure appropriately. After the link is established, and if periodic interference is detected, transmission occurs during the inactive period of the interference.

### BRIEF DESCRIPTION OF THE DRAWINGS

A better understanding of the invention is obtained when the following detailed description is considered in conjunction with the following drawings in which:

FIG. 1 is a time domain plot of a microwave oven;

FIG. 2 is a diagram of an exemplary cordless telephone system according to an implementation of the invention;

FIG. 3 is a diagram of exemplary frame frequencies for a frequency hopping cordless telephone system according to an implementation of the invention; and

FIG. 4 is a flowchart illustrating operation of an implementation of the invention.

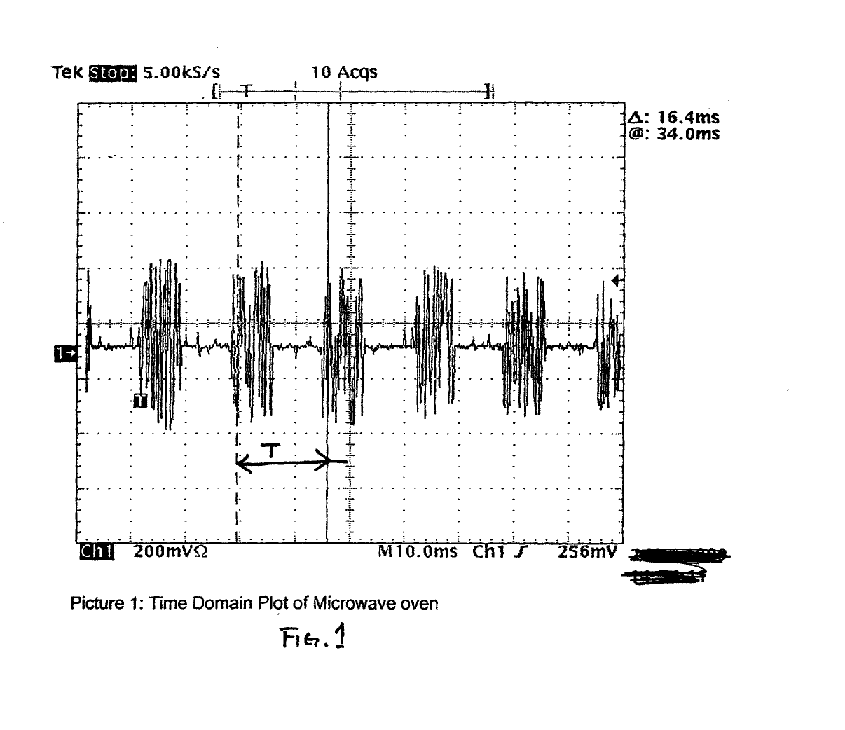

### DETAILED DESCRIPTION OF THE INVENTION

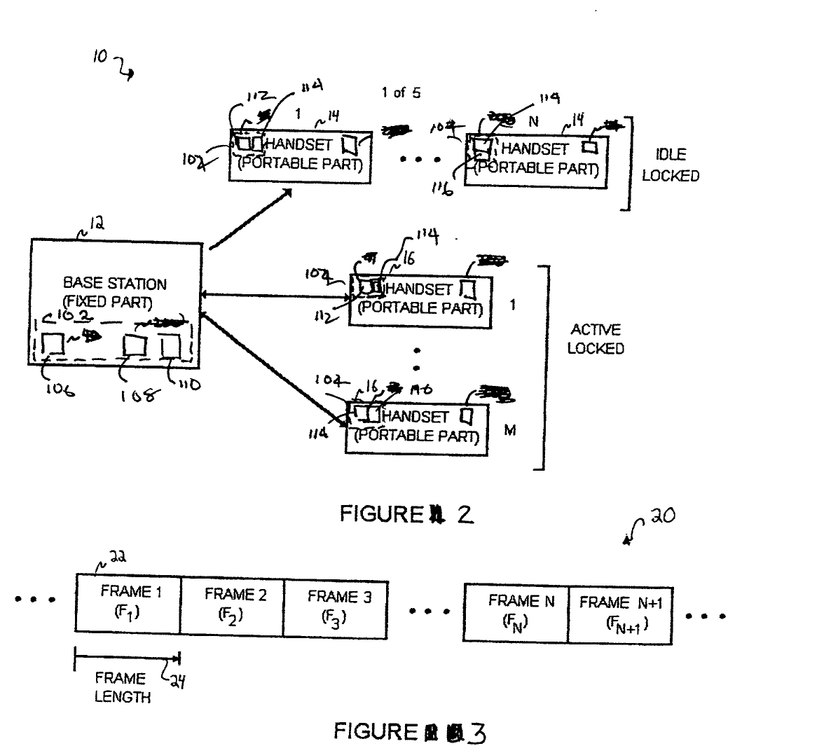

FIGS. 2-4 illustrate a telecommunications system including telecommunications devices according to an implementation of the present invention. A base station according to an implementation of the invention is adapted to identify a public power supply frequency, e.g., 50 Hz or 60 Hz. The base station then adapts its frame and slot structures to the power supply frequency. The base station transmits a synchronization word on a data channel, and also transmits a signal indicative of the power supply frequency. The mobile unit receives the data channel and the information indicative of the frequency. The mobile unit then adapts its frame and slot structure appropriately. After the link is established, and if periodic interference is detected, transmission occurs during the inactive period of the interference.

FIG. 2 is a block diagram of one implementation of an exemplary radiofrequency system according to the present invention. In particular, the system may be implemented as a frequency hopping cordless telephone system, indicated generally as 10. The system 10 includes one or more base stations 12, each of which can also be referred to as a fixed part (FP). Each base station 12 can support communication with a plurality of mobile units or handsets 14 and handsets 16 using radio frequencies. The interface between base station 12 and handsets 14 and 16 can be referred to as the air interface. The base station 12 includes control logic 102 and the handsets 14 and 16 include control logic 104 according to the present invention, as will be explained in greater detail below. An exemplary system suitable for use with a system according to the present invention is the Gigaset system, available from Siemens Corp.

In operation, base station 12 can support a defined total number of handsets 14 and 16. For example, in one implementation, base station 12 can support a total of eight handsets, either idle locked or active locked. Of the total number of handsets, a given number ‘M” can be active locked handsets 16. For example, base station 12 could support up to four active locked handsets 16 from the eight total handsets. Of the remaining handsets, base station 12 can support a given number ∓N’ of idle locked handsets 14. For example, “N” can be less than or equal to the difference between the total number of supported handsets (e.g., 8) and the number “M” of active locked handsets 16 (e.g., 0-4). Idle locked handsets 14 are handsets that are currently inactive but are in contact with and in sync with base station 12. Base station 12 can communicate with handsets 14 and handsets 16 using a time division multiplexed (TDM) frame-based communication protocol.

In the implementation of FIG. 2, the system 10 uses an ISM band of radio frequencies for supporting communication between base station 12 and handsets 14 and 16. For example, the system 10 can use the ISM band extending from 2.4 GHz to 2.4835 GHz. An advantage of using the ISM band is that it is unlicensed and does not require a license fee for use. However, in order to operate within FCC or other government regulations, the system 10 implements a frequency hopping scheme. This allows the system 10 to support robust cordless communications in the ISM band while operating within regulation guidelines. Under the frequency hopping scheme, base station 12 and handsets 14 and 16 move in the time domain from frequency to frequency.

Because of the changing frequency, handsets are initially in an unlocked state when entering an area serviced by base station 12. Unlocked handsets can then “listen” at a specific radio frequency to attempt to lock on to base station 12. When base station 12 hops to that specific frequency, unlocked handsets can identify and receive control data transmitted by base station 12. This allows unlocked handsets to lock with base station 12 and sync with the frequency hopping scheme. Further, as will be explained in greater detail below, the control data allows the handsets 14 and 16 to determine a power supply frequency and adjust its frame and slot structure to correspond to a specific power supply frequency structure.

More particularly, the control logic 102 of the base station 12 includes a power supply identification unit 106, one or more codecs 108, and a controller 110. Similarly, the control logic 104 of the handsets 14,16 include receivers 112 and controllers 114. It is noted that, while described as discrete units, typically, the control logic 102's and control logic 104's functionality is implemented as one or more integrated circuits, such as application specific integrated circuits, microcontrollers, microprocessors, or digital signal processors.

As noted above, typical public power supply frequencies are 50 Hz and 60 Hz. The codec 106 of the mobile station is adapted to encode data at a rate that is a multiple of both 50 and 60. The codecs (not shown) of the handsets 14, 16 encode data at the same rate.

In operation, the power supply identification unit 106 determines whether the power supply is a 50 Hz or 60 Hz source. For example, the power supply identification unit 108 may monitor directly the power supply frequency or may receive an external input, such as by factory or user setting. In response, the controller 110 sets the frame and slot structure accordingly. This information is provided to unlocked handsets via their receivers 112, during synchronization, in certain implementations over the data channel. The controllers 114 of the unlocked handsets then adjust their frame structure to match.

Operation of the present invention may be explained by way of example. In one implementation, two different frame lengths are possible (corresponding to the 50 and 60 Hz systems): 20 milliseconds, corresponding to 1/50 Hz; and 16.6 milliseconds, corresponding to 1/60 Hz. Then, the codec data rates are respectively X/50 and X/60, where X is the codec data rate. If X=24 kbits/second, then 480 bits can be transmitted per frame in the 50 Hz system, and 400 bits can be transmitted per frame in the 60 Hz system. Any slot structure corresponding to these numbers of bits per frame maybe used, and the same speech codec may be used for both systems.

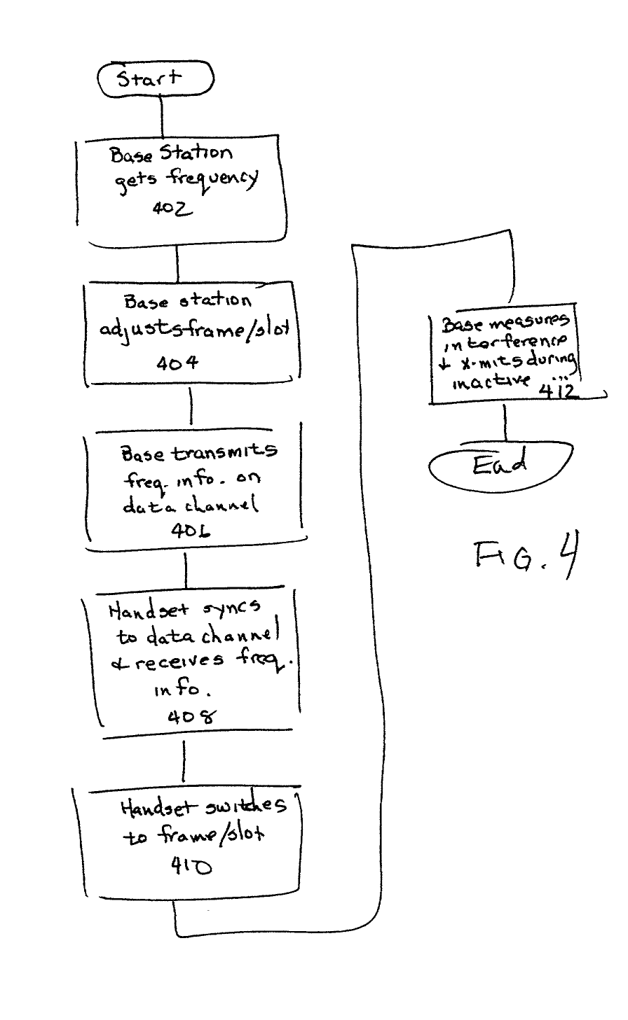

FIG. 3 is a block diagram of one embodiment of frame frequencies for a frequency hopping cordless telephone system. As shown, a frame structure, indicated generally at 20, comprises a plurality of frames 22 each having a frame length 24. In the implementation discussed above, the frame length may be 16.6 or 20 milliseconds. Each frame 22 follows immediately after the previous frame 22 in the time domain. In the embodiment of FIG. 2, a different frequency (F₁, F₂, F₃ . . . F_{N}, F_{N+1}, . . . ) is associated with each frame 22 and is used during that frame 22 for communication across the air interface between base station 12 and handsets 14 and 16. This change from frequency to frequency is handled by the frequency hopping scheme implemented by base station 12 and handsets 14 and 16. During the duration of a given frame 22, base station 12 and handsets 14 and 16 communicate using the selected frequency for that frame 22. When the next frame 22 begins, base station 12 and handsets 14 andl6 communicate using a new selected frequency. As noted above, the frame length may be either 16.6 or 20 milliseconds. Thus, the frequency being used changes every 16.6 or 20 milliseconds, as described above. An exemplary frequency hopping scheme is described in U.S. patent application Ser. No. 09/113,539 filed Jun. 10, 1998, titled “Method and System for Table Implemented Frequency Selection in a Frequency Hopping Cordless Telephone System,” which is hereby incorporated by reference in its entirety as if fully set forth herein.

Turning now to FIG. 4, a flowchart illustrating operation of an implementation of the invention is shown. In a step 402, the base station obtains the frequency of the public power supply. As discussed above, this may occur either via direct measurement or external input. In a step 404, the control logic 102 adjusts the frame and slot structure to correspond to the public power supply frequency. In a step 406, the control logic 102 opens a data channel to one or more handsets, transmitting the power supply frequency information. The data channel is used to transmit a synchronization word as well as the frequency information. In a step 408, the receiver 114 of the handsets receives the power supply frequency information, which may be supplied as one or more indication bits. In a step 410, the control logic 104 of the handset(s) adjusts their frame and slot structure to correspond to the power supply frequency. In a step 412, the base station 12 listens for interference based on the power supply frequency, such as that from a microwave oven. In particular, the base station determines if the interference is during the positive or negative half-wave of the public power supply frequency, and adjusts to transmit and receive all slots during the inactive period.

The invention described in the above detailed description is not intended to be limited to the specific form set forth herein, but is intended to cover such alternatives, modifications and equivalents as can reasonably be included within the spirit and scope of the appended claims.

What is claimed is:

1. A telecommunications system, comprising:
a base station; and
one or more mobile units;
wherein said base station and one or more mobile units are adapted to adapt a frame length to a power supply frequency.

2. A telecommunications system in accordance with claim 1, wherein said base station is adapted to determine said power supply frequency and transmit a signal indicative of said power supply frequency to said one or more mobile units.

3. A telecommunications system in accordance with claim 2, wherein said base station and said one ore more mobile units communicate during non-interfered with half-waves of said power supply frequency.

4. A telecommunications system in accordance with claim 2, wherein a codec rate is the same for a plurality of power supply frequencies.

5. A telecommunications method, comprising:
providing a base station; and
providing one or more mobile units;
wherein said base station and one or more mobile units are adapted to adapt a frame length to a power supply frequency.

6. A telecommunications method in accordance with claim 5, wherein said base station is adapted to determine said power supply frequency and transmit a signal indicative of said power supply frequency to said one or more mobile units.

7. A telecommunications method, in accordance with claim 6, wherein said base station and said one ore more mobile units communicate during non-interfered with half-waves of said power supply frequency.

8. A telecommunications method in accordance with claim 7, wherein a codec rate is the same for a plurality of power supply frequencies.

9. A telecommunications method, comprising:
identifying a power supply frequency; and
adapting a frame length to said power supply frequency.

10. A telecommunications method in accordance with claim 9, said adapting comprising transmitting at a same codec rate for a plurality of power supply frequencies.

11. A telecommunications method in accordance with claim 10, further comprising communicating during non-interfered with half-waves of said power supply frequency.

12. A base station unit for use in a telecommunications system, comprising:
a controller adapted to determine a power supply frequency and determine a frame structure in response thereto; and
a codec for transmitting data using a plurality of said frame structures.

13. A base station unit in accordance with claim 12, including means for transmitting a signal to one or more mobile units indicative of a power supply frequency.

14. A base station unit in accordance with claim 13, said transmitting means including means for communicating during non-interfered with half-waves of said power supply frequency.

15. A telecommunications mobile unit; comprising:
a receiver for receiving one or more control signals indicative of a power supply frequency; and
a controller for changing a frame and slot structure corresponding to said power supply frequency.

16. A telecommunications mobile unit in accordance with claim 15, wherein said controller is adapted to maintain a same data rate regardless of said power supply frequency.

17. A telecommunications mobile unit in accordance with claim 16, said controller adapted to communicate during non-interfered with half-waves of said power supply frequency.
